(19) United States
(12) Patent Application Publication
(10) Pub. No.: US 2017/0288747 A1
(43) Pub. Date: Oct. 5, 2017

(54) WIRELESS DEVICE AND METHOD FOR ITERATIVE DECODING FOR MU-MIMO WIRELESS SYSTEMS

(71) Applicants: CHIA-HSIANG CHEN, Sunnyvale, CA (US); MOHAMED K. HASSANIN, SunnyVale, CA (US); AHMED GAMAL HELMY MOHAMED, Richardson, TX (US); SHAHRNAZ AZIZI, Cupertino, CA (US); FARHANA SHEIKH, Hillsboro, OR (US); ASSAF GUREVITZ, Ramat Hasharon (IL); THOMAS J. KENNEY, Portland, OR (US)

(72) Inventors: CHIA-HSIANG CHEN, Sunnyvale, CA (US); MOHAMED K. HASSANIN, SunnyVale, CA (US); AHMED GAMAL HELMY MOHAMED, Richardson, TX (US); SHAHRNAZ AZIZI, Cupertino, CA (US); FARHANA SHEIKH, Hillsboro, OR (US); ASSAF GUREVITZ, Ramat Hasharon (IL); THOMAS J. KENNEY, Portland, OR (US)

(21) Appl. No.: 15/084,977

(22) Filed: Mar. 30, 2016

(51) Int. Cl. H04B 7/04; H04B 1/7105

(52) U.S. Cl. CPC H04B 7/0452; H04B 1/71055

(57) ABSTRACT

Embodiments relate to systems, methods, and computer readable media to enable a wireless receiver are described. In one embodiment a wireless receiver includes a channel decoder and a Soft-Input Soft-Output Multiple-Input Multiple-Output detector (SISO MIMO detector). The SISO MIMO detector includes circuitry to generate soft symbol outputs for each of a plurality of received spatial streams, and circuitry to adjust a signal to noise plus interference ratio for the soft symbol outputs using channel statistics and using hard decisions from an output of the channel decoder. The channel decoder is configured to receive soft binary information generated from the soft symbol outputs from the SISO MIMO detector and perform these steps iteratively a number of times.

### TECHNICAL FIELD

Embodiments pertain to wireless networks. Some embodiments relate to wireless local area networks (WLANs) and Wi-Fi networks including networks operating in accordance with the IEEE 802.11 family of standards, such as the IEEE 802.11ac standard or the IEEE 802.11ax study group (SG) (named DensiFi). Some embodiments relate to high-efficiency (HE) wireless or high-efficiency WLAN or Wi-Fi (HEW) communications. Some embodiments relate to multi-user (MU) multiple-input multiple-output (MIMO) communications and orthogonal frequency division multiple access (OFDMA) communication techniques. Some embodiments relate to decoding techniques, including iterative decoding.

### BACKGROUND

10021 Wireless communications has been evolving toward ever increasing data rates (e.g., from IEEE 802.11a/g to IEEE 802.11n to IEEE 802.11ac). In high-density deployment situations, overall system efficiency may become more important than higher data rates. For example, in high-density hotspot and cellular offloading scenarios, many devices competing for the wireless medium may have low to moderate data rate usage needs (with respect to the very high data rates of IEEE 802.11ac). A recently-formed study group for Wi-Fi evolution referred to as the IEEE 802.11 High Efficiency WLAN (HEW) study group (SG) (i.e., IEEE 802.11ax) is addressing these high-density deployment scenarios.

### BRIEF DESCRIPTION OF THE DRAWINGS

FIG. 1 is a block diagram of a station (STA) and an access point, each having 8 antennas for an 8×8 system with 8 receive spatial streams that may be used with various embodiments described herein.

FIG. 2 shows a comparison between SU-MIMO independent decoding and detection and joint decoding and detection for Binary Phase Shift Keying (BPSK), 16-Quadrature Amplitude Modulation (16-QAM) and 64-QAM.

FIG. 3 illustrates a Multi-User MIMO (MU-MIMO) wireless communication system with four station devices each station device equipped with 2 antenna elements.

FIG. 4 illustrates various hardware modules of one embodiment of an access point 400 implementing iterative decoding with hard decision feedback.

FIG. 5 is an operational block diagram of iterative decoding using hard feedback from the channel decoder in accordance with some embodiments described herein.

FIG. 6 illustrates an Error Vector Magnitude (EVM) for the In-Phase channel of a 16-Quadrature Amplitude Modulation (QAM) signal in accordance with some embodiments.

FIG. 7 is a block diagram of an iterative detector comprising a Soft-Input Soft-Output Multiple-Input Multiple-Output detector and a channel decoder, to detect a Low Density Parity Code (LDPC) using hard decision feedback from the channel decoder in accordance with some embodiments described herein.

FIG. 8 is a block diagram of an iterative decoder comprising a SISO MIMO detector and a channel decoder, to detect a Block Convolutional Code (BCC) using hard decision feedback from the channel decoder in accordance with some embodiments described herein.

FIG. 9 shows the performance difference when implementing iterative decoding using soft decision feedback and when using hard decision feedback from the channel decoder for a 2×2 MIMO system in accordance with some embodiments described herein.

FIG. 10 illustrates a wireless LAN showing an Access Point, Station Devices and Hew Devices that may be used in accordance with some embodiments described herein.

FIG. 11 illustrates a user station (STA) and an access point (AP) in accordance with some embodiments described herein.

### DETAILED DESCRIPTION

Embodiments relate to systems, devices, apparatus, assemblies, methods, and computer readable media to enhance wireless communications, and particularly to communication systems involved with Multiple User—Multiple Input Multiple Output (MU-MIMO) systems. The following description and the drawings illustrate specific embodiments to enable those skilled in the art to practice them. Other embodiments can incorporate structural, logical, electrical, process, and other changes. Portions and features of some embodiments can be included in, or substituted for, those of other embodiments, and are intended to cover all available equivalents of the elements described.

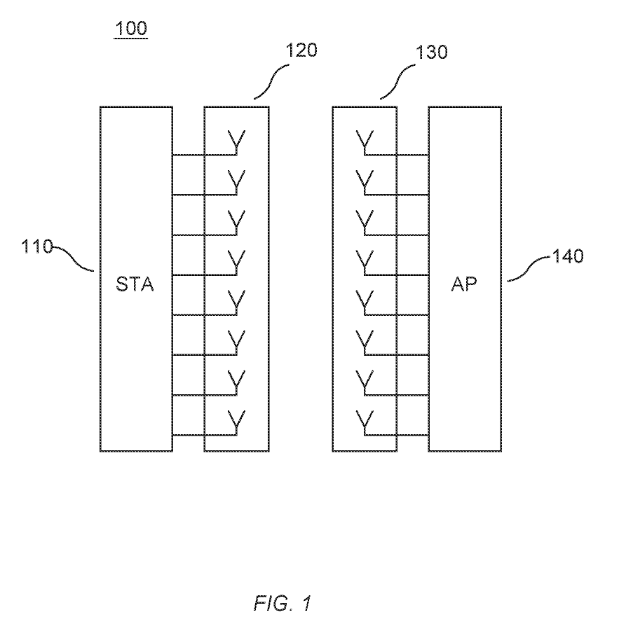

FIG. 1 is a block diagram of a station (STA) and an access point, each having 8 antennas for an 8×8 system with 8 receive spatial streams that may be used with various embodiments described herein. It is specifically showing a system 100 for Single-User Multiple-Input Multiple-Output (SU-MIMO) wireless communication between a wireless access point 140 and a station device 110. Both are equipped with antenna arrays, 120 and 130, each consisting of 8 antenna elements to form an 8×8 system with 8 spatial streams.

Wi-Fi networks and other wireless systems such as 3GPP and LTE use Multiple Input Multiple Output (MIMO) techniques to improve received SNR through spatial diversity. This is achieved by the use of multiple antennas at a receiver performing various signal processing operations from each antenna. This allows the transceiver to adapt to channel impairments such as multipath and to provide diversity gain.

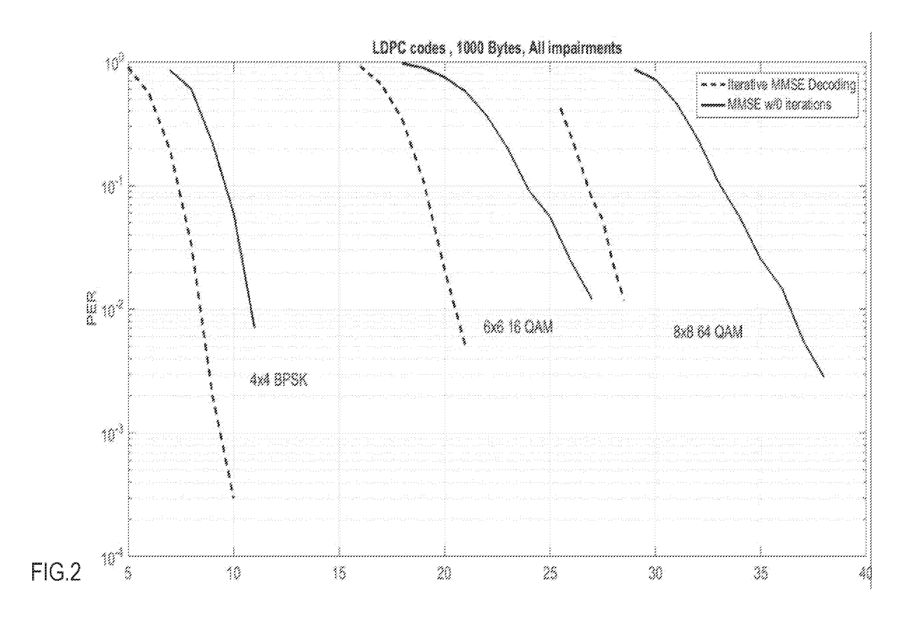

FIG. 2 shows a comparison between SU-MIMO independent decoding and detection and joint decoding and detection for Binary Phase Shift Keying (BPSK), 16-Quadrature Amplitude Modulation (16-QAM) and 64-QAM. The joint decoding and detection provides a one to eight decibel improvement over the more traditional approach of performing MMSE channel detection and decoding independently. This is the result of allowing the SISO MIMO detector (channel de-mapper) to use information from the code structure to provide the optimal signal to noise plus interference ratio.

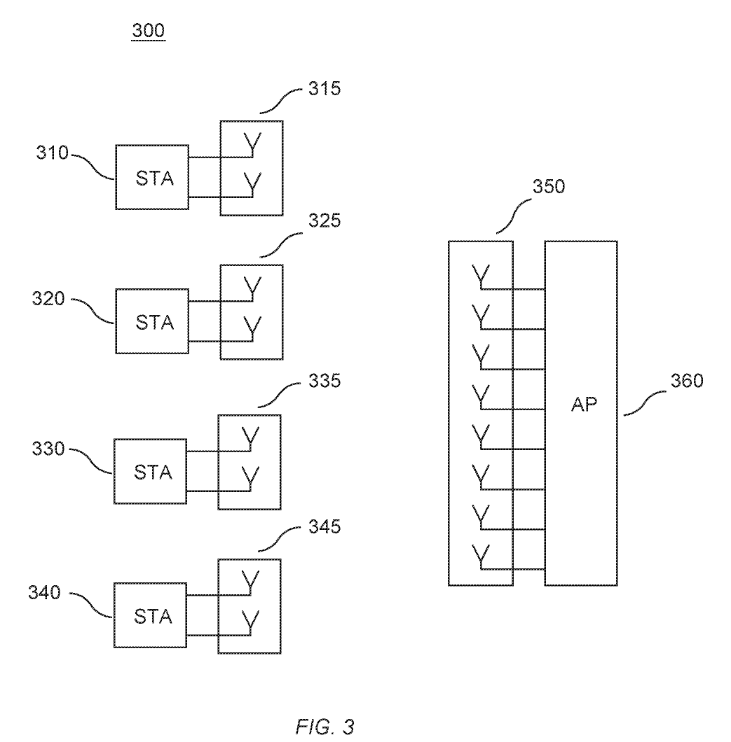

FIG. 3 illustrates a Multi-User MIMO (MU-MIMO) wireless communication system 300 with 4 station devices 310, 320, 330 and 340, each station device equipped with 2 antenna elements, 315, 325, 335, and 345. This provides up to a maximum of 8 independent transmit streams. The receiver 360 has an array of 8 antenna elements 350. The extra antenna elements 350 at the access point 360 provide receiver diversity and power gain. A Multiple User-Multiple Input Multiple Output (MU-MIMO) system allows the transceiver to achieve some degree of multiple access between users based on the spatial channel separation of the transmit streams. This is sometimes referred to as space-division multiple access. Using MU-MIMO techniques, a wireless receiver or access point may simultaneously receive a plurality of transmit streams in the same bandwidth. The receiver has at least as many antenna elements as there are independent uplink transmit streams to allow for simultaneous spatial multiplexing. The term wireless access point may refer to a wireless router, a wireless base station, a wireless bridge or any wireless transceiver that is equipped to receive multiple spatial streams simultaneously through a plurality of antenna elements. The term station device may refer to user equipment, end-user equipment, a wireless network adapter, or a wireless network card. The iterative joint decoding and detection of MU-MIMO receive processing provides a means to increase the signal to noise plus interference ratio by using information obtained from the code structure.

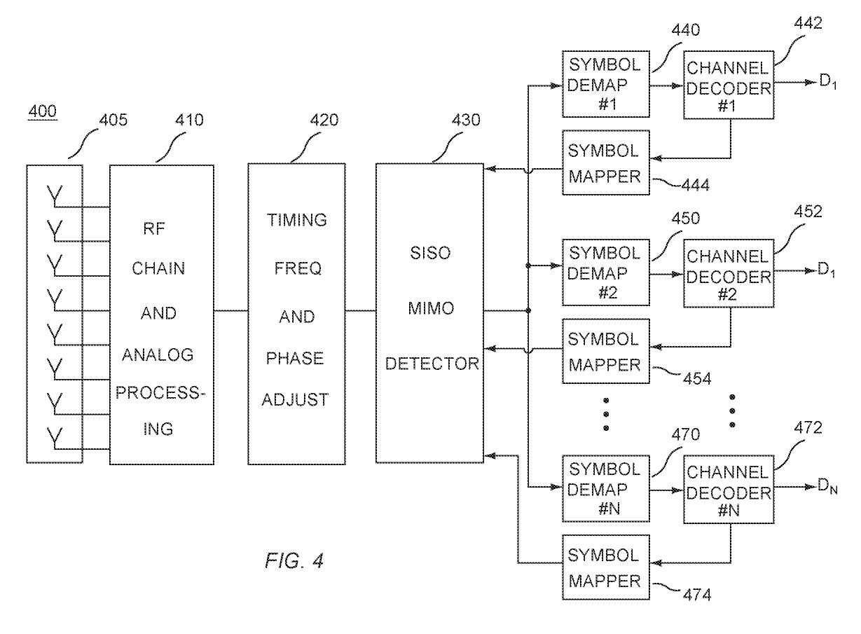

FIG. 4 illustrates various hardware modules of one embodiment of an access point 400 implementing iterative decoding with hard decision feedback. It comprises an antenna array 405 of eight antenna elements, an RF Chain and Analog Processing 410 which includes normal RF circuitry such as Low Noise Amplifiers (LNAs), mixers, amplifiers, filters, Analog-to-Digital (A/D) converters and receiver Fast Fourier Transform (FFT) signal processing for Orthogonal Frequency Division Multiple access (OFDM). Block 420 provides timing, frequency and phase correction as needed since the station devices (STA) are not aligned and transmitting independently of each other. The outputs of block 420 are then passed to the Soft-Input Soft-Output Multiple-Input Multiple Output (SISO MIMO) detector. The SISO MIMO detector 430 separates out the uplink spatial streams by Minimum Mean Square Error (MMSE) linear filtering and provides soft symbols for channel decoding for each spatial stream. The symbol de-mappers 440, 450 and 470 map the soft symbols to binary Log-Likelihood Ratios (LLRs). The channel decoders 442, 452, and 472 perform soft error correction generating a new set of LLRs for each spatial stream. A binary hard decision is made for each binary LLR depending on whether a one or a zero is more likely. The binary hard decisions are then passed back to the Symbol mappers, 444, 454, and 474 which produce an updated set of hard decision symbols for the SISO MIMO detector 430. The SISO MIMO detector 430 then adjusts the weighted values incorporating the hard decision symbol updates. The embodiments shown here is for a typical access point and not intended to limit the possible variations that fall within the scope of this application.

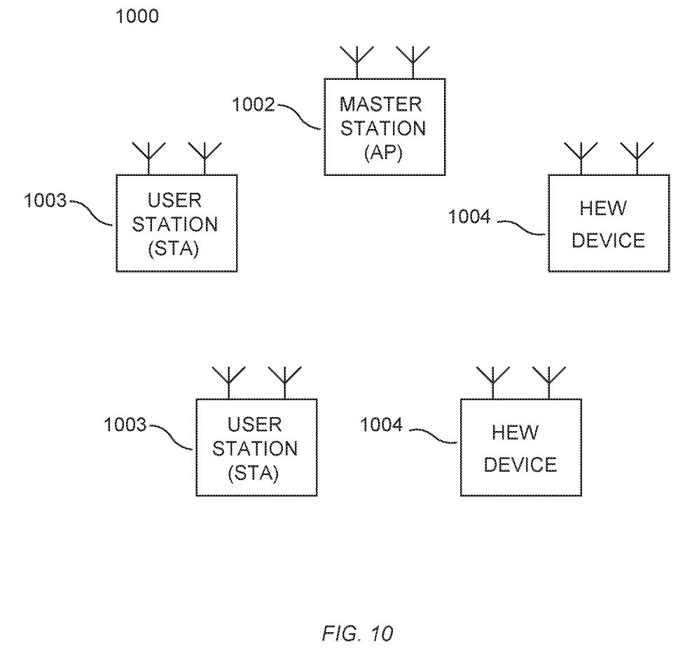

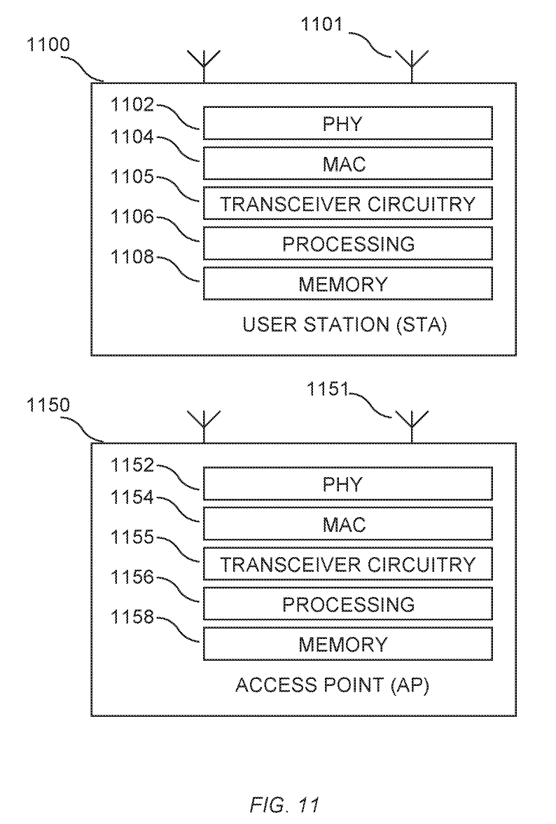

In various embodiments, elements of access point 400 shown in FIG. 4 are used to implement any access point described herein, such as access point 140 of FIG. 4, access point 360 of FIG. 3, access point 1002 of FIG. 10, or access point 1150 of FIG. 11. In some embodiments, the elements described in access point 400 of FIG. 4 may be used in different combinations, or with additional repeated elements or other elements used between or around the elements illustrated in FIG. 4, while still operating in accordance with the embodiments described herein.

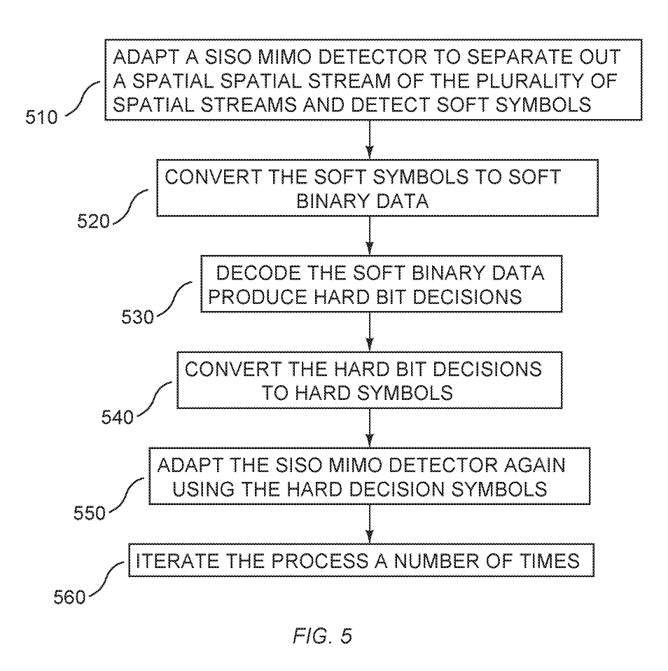

FIG. 5 is an operational block diagram of iterative decoding using hard feedback from the channel decoder in accordance with some embodiments described herein. Initially, the wireless device receives a plurality of spatial streams on a plurality of antennas so that the total signal energy received from any one stream is distributed to some or all of the receiving antennas. In operation 510 the SISO MIMO detector separates out the spatial streams from the plurality of spatial streams and detects soft symbols for each spatial stream. The SISO MIMO detector is implementing a linear filtering scheme combining information from each antenna input to provide an output stream. The soft symbols are generated from channel statistics collected by the SISO MIMO detector along with the samples of each received symbol. In operation 520, the soft symbols are converted to soft binary data where the soft binary date may be in the form binary likelihood ratios, binary Log-Likelihood Ratios (LLR) or some other form that conveys probability information for each given bit. A binary Log-Likelihood Ratio is the log function of the probability that the received bit is a one, divided by the probability that the received bit is a zero. The operations are often performed in the log-domain which transforms multiplications into additions providing a simplification in hardware. Also, the logarithmic implementation helps to resolve numerical stability problems that arise when multiplying many probabilities ratios that come very close to zero for large block lengths. In 530, the channel decoder performs soft decoding on the soft binary data and generates hard bit decisions. In 540, the hard bit decisions are converted to hard symbols so that each hard symbol is specifically mapped to one of the constellation points in an In-Phase Quadrature-Phase (IQ) constellation diagram for that particular modulation format. In operation 550, the SISO MIMO detector is adjusted using the hard decision symbols to create a new set of soft symbol outputs. This can be done with Minimum Mean Square Error (MMSE), Zero Forcing (ZF) etc. Here, the hard decision feedback from the channel decoder provides information about the code structure that the SISO MIMO detector employs to further improve the signal to noise plus interference ratio for each spatial stream. Operation 560, the above procedure is iterated one or more times.

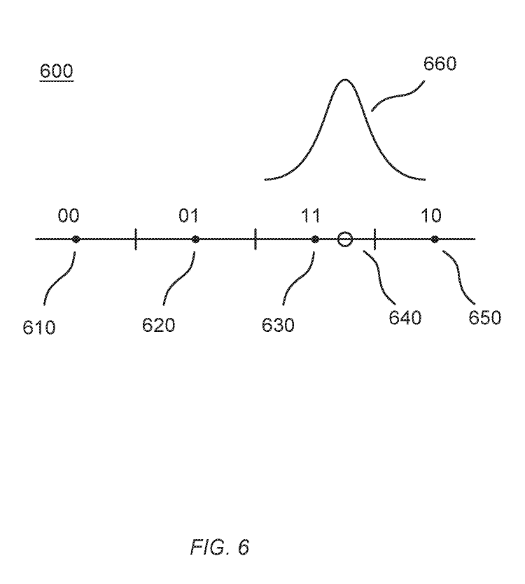

FIG. 6 illustrates an Error Vector Magnitude (EVM) for the In-Phase channel of a 16-Quadrature Amplitude Modulation (QAM) signal in accordance with some embodiments. The fixed constellation points 610, 620, 630 and 650 are shown along with the soft code symbol output, 640. Distribution 660 shows the probability distribution for the soft symbol which allows for the calculation of the Log-Likelihood Ratio of each corresponding bit. The probability distribution is estimated using channel statistics as provided by the SISO MIMO detector.

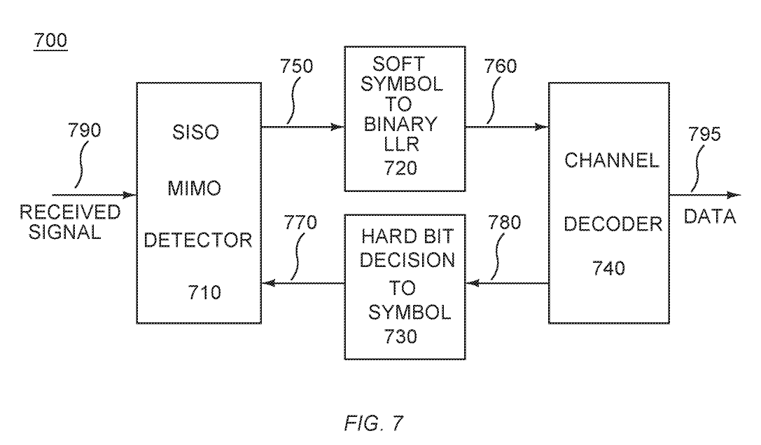

FIG. 7 is a block diagram of an iterative detector comprising a Soft-Input Soft-Output Multiple-input Multiple-Output detector and a channel decoder, to detect a Low Density Parity Code (LDPC) using hard decision feedback from the channel decoder in accordance with some embodiments described herein. The SISO MIMO detector 710 is a matched filter taking inputs from each antenna and separating out each uplink spatial stream. The matched filter is adjusted to improve the optimal signal to noise plus interference ratio (where the interference includes energy from other spatial streams that are transmitted simultaneously) as determined by MMSE. Then, the SISO MIMO detector provides soft symbol estimates 750 to the soft symbol to binary Log-Likelihood Ratio (LLR) conversion module 720. The SISO MIMO Detector accomplishes this through channel statistics to estimate of the variance and probability distribution (PDF) for each spatial stream. The soft symbol to binary LLR conversion module 720 provides the binary LLRs 760 to the channel decoder 740. The channel decoder performs soft error correction on the binary LLRs and generates a hard bit decision for each binary LLR depending on whether a one or a zero is more likely. The hard bit decisions 780 are passed to the symbol mapper 730. The symbol mapper produces a set of hard symbols 770 which are returned to the SISO MIMO detector 710. The hard symbols are defined by the IQ constellation points of the given modulation format (64-QAM for example). The SISO MIMO detector 710 repeats the detection process creating a new set of soft symbols using the hard symbol feedback. Particularly, the SISO MIMO detector 710 is using information about the structure of the code as provided by the channel decoder 740 in the form of hard binary decisions 780 to adjust the SISO MIMO detector 710. The benefit of using hard binary decisions 780 in terms of the reduction in computational complexity is discussed below. The iteration can continue for a fixed number of cycles, after which the jointly decoded and detected data 795 is output.

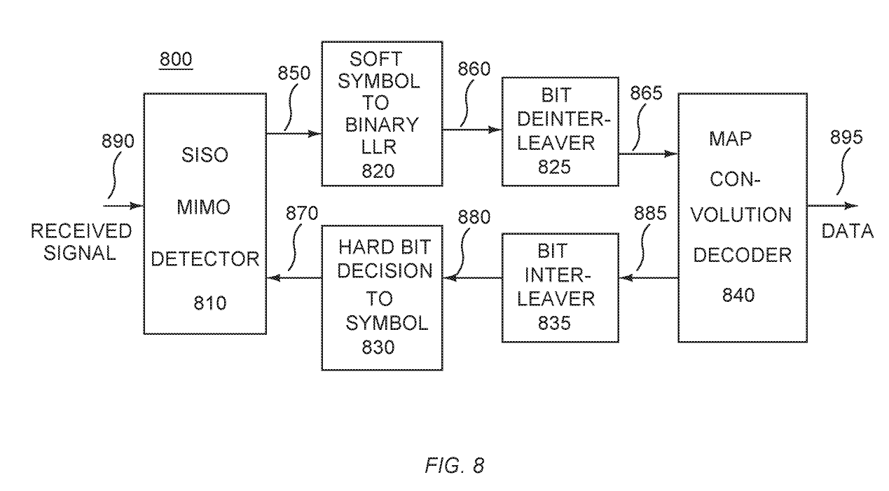

FIG. 8 is a block diagram of an iterative decoder comprising a SISO MIMO detector and a channel decoder, to detect a Block Convolutional Code (BCC) using hard decision feedback from the channel decoder in accordance with some embodiments described herein. As in FIG. 7, the received signal 890 is detected by the SISO MIMO detector 810 performing spatial separation between a plurality of uplink spatial streams (channel de-mapping) and generating a set of soft symbols for each received spatial stream. The soft symbols 850 are passed through the symbol to binary LLR converter 820 giving LLRs 860. The binary LLRs are De-Interleaved by 825, and soft code correction is performed by the MAP Convolution Decoder 840. The Maximum A Posteriori (MAP) convolution Decoder 840 generates a new set of binary LLRs. A hard bit decision is made for each binary LLR depending based on whether a one or a zero is more likely. The hard bit decisions 860 are inter-leaved through 820. The interleaved hard decision bits 880 are passed to the symbol mapper 830. Finally, the hard decision symbols 870 are provided to the SISO MIMO 810 detector. The SISO MIMO detector 810 then continues creating a new set of soft symbols for each spatial stream. The procedure is then iterated for a fixed number of cycles, after which the jointly decoded and detected data is output 895.

Shown in FIG. 7 and FIG. 8 are iterative decoding systems for LDPC and BCC, respectively. However, the iterative decoding and detection scheme can be applied to any Forward Error Correction (FEC) code that can be iteratively decoded. Also the modulation format can be anything as represented on an In-Phase Quadrature-Phase (IQ) constellation map of the symbols. The modules shown in FIG. 7 and FIG. 8 could be implemented in a variety of ways. For example, the entire joint detection and decoding could be performed on a single Application Specific Integrated Circuit (ASIC) or a Field Programmable Gate Array (FPGA) or a programmable logic device. The functioning could be combined or divided into multiple digital processing units. The implementation could even be implemented with a software routine if the digital processor was fast enough.

Also, there is no requirement that each uplink spatial stream use the same modulation format and code. In other words, one uplink spatial stream may use a certain modulation format and coding type, and another uplink spatial stream may use a different modulation format and a different type of coding. This could allow legacy devices to participate in the MU-MIMO uplink communications with an access point which implements joint MU-MIMO detection and decoding.

In some systems, joint detection and decoding is performed with soft-decision feedback from the channel decoder. With this method, the soft-symbols are calculated from the soft LLRs as computed by the channel decoder. In one possible method for exactly computing the soft symbols, each LLR is converted to linear probability according to the following equation.

$${P}_{m} = \frac{{e}^{\frac{1}{2} {LLR}_{m}}}{{e}^{\frac{1}{2} {LLR}_{m}} + {e}^{- \frac{1}{2} {LLR}_{m}}} \qquad ( 1 )$$

where Pₘ corresponds to the probability that the mth bit is a one. Then for a set of bits representing the Kth symbol, the probability for each possible symbol is determined symbol set is calculated as:

$$\begin{matrix}{P}_{K} = {\prod }_{j = 1}^{n} f ( {P}_{{K}_{j}} ) & ( 2 ) \\ f ( {P}_{{K}_{j}} ) = \{ \begin{matrix}{P}_{j} & {K}_{j} = 1 \\ 1 - {P}_{j} & {K}_{j} = 0\end{matrix} & ( 3 )\end{matrix}$$

where there are n bits representing each symbol and a total of 2ⁿ possible constellation symbols in the symbol set. Then the soft symbol can be computed as

[symbol]

=Σ_{K=1}²^{ⁿ}P_{K}·Sₖ (4)

where Sₖ is a constellation symbol represented in complex vector format and s is the soft symbol estimate.
A linear approximation of the soft-decision feedback which reduces the number of calculations that are performed is used in some systems. First the LLRs are converted to linear probabilities as discussed above.

$${P}_{m} = \frac{{e}^{\frac{1}{2} {LLR}_{m}}}{{e}^{\frac{1}{2} {LLR}_{m}} + {e}^{- \frac{1}{2} {LLR}_{m}}} \qquad ( 5 )$$

where Pₘ corresponds to the probability that the mth bit is a one. Next, the following equations are used to calculate the real and imaginary components of the of the soft symbol estimate according to the modulation format used.

TABLE 1

| | [symbol] {ŝᵢ} = a(sᵢ) |
|---|---|
| BPSK | 1 − 2p_{i,1} |
| 4-QAM | 1 − 2p_{i,1} |
| 16-QAM | (1 − 2p_{i,1})(1 + 2p_{i,2}) |
| 64-QAM | (1 − 2p_{i,1})(4p_{i,2}p_{i,3} + 2p_{i,2} − 2p_{i,3} + 3) |
| | [symbol] {ŝᵢ} = b(sᵢ) |
| BPSK | 0 |
| 4-QAM | 1 − 2p_{i,2} |
| 16-QAM | (1 − 2p_{i,3})(1 + 2p_{i,4}) |
| 64-QAM | (1 − 2p_{i,4})(4p_{i,5}p_{i,6} + 2p_{i,5} − 2p_{i,6} + 3) |

Here, p_{i,x} corresponds to probability that the xth bit corresponding to ith symbol is zero. In the embodiments described previously using hard decision feedback, the LLRs are converted to binary hard decisions according to each LLR. The hard decision bits are then mapped back to a hard symbols representing actual signal constellation points. In this manner, the calculation steps to determine a soft symbol estimate from the soft LLRs are totally bypassed. All of the multiplication and additions that are used previous work for this function are unnecessary. The following tables summarize a comparison of the reduction in hardware needs in terms of arithmetic operations and look up tables (LUT) needed to produce the soft symbol estimates from the LLR outputs of the decoder.

The comparison illustrated by Table 2 shows the exact soft-symbol calculation method, the linear approximation method, and the reduction in hardware in the proposed by this embodiment for 16-QAM.

TABLE 2
Complexity Comparison per Symbol Calculation in 16-QAM

| Design | LUT | | | |
|---|---|---|---|---|
| Method | (Probability) | Multiplications | Additions | Limitation |
| Exact | 4 | 8 (step 2) | 8 (step 3) | No |
| soft-symbol | | 8 (step 3) | | |
| calculation | | | | |
| Linear- | 4 | 2 (step 2) | 4 (step 2) | Yes, |
| approximated | | | | constellation |
| soft-symbol | | | | map is |
| calculation | | | | strictly |
| | | | | fixed |
| Proposed hard | 0 | 0 | 0 | No |
| symbol routing | | | | |

The comparison illustrated by Table 3 shows the exact soft-symbol calculation method, the linear approximation method, and the reduction in hardware in the proposed by this embodiment for 64-QAM.

TABLE 3
Complexity Comparison per Symbol Calculation in 64-QAM

| Design | LUT | | | |
|---|---|---|---|---|
| Method | (Probability) | Multiplications | Additions | Limitation |
| Exact | 6 | 16 (step 2) | 16 (step 3) | No |
| soft-symbol | | 16 (step 3) | | |
| calculation | | | | |
| Linear- | 6 | 4 (step 2) | 8 (step 2) | Yes, |
| approximated | | | | constellation |
| soft-symbol | | | | map is |
| calculation | | | | strictly |
| | | | | fixed |
| Proposed hard | 0 | 0 | 0 | No |
| symbol routing | | | | |

Because the Symbol Mapper 730 maps the hard decisions from the decoder, no multiplication, addition or soft symbol calculations are needed.

Further reductions are achieved by the fact that the SISO MIMO detector 710, in FIG. 7, operates on a smaller word length. For example, in 16 QAM the In-phase and Quadrature-Phase constellations points are each defined by only 2 bits. In 64-QAM, the In-phase and Quadrature-Phase constellations are each defined by only 3 bits. For these cases, the SISO MIMO detector is operating on 2 or 3 bit words to perform the interference cancellation instead the 5 to 10 bit words that would be provided by soft symbol estimates.

Another hardware reduction is that the memory buffer between the channel decoder and the SIS MIMO detector is significantly reduced in size. Normally the soft LLRs are quantized somewhere from 5 to 10 bits. For an LDPC Code-word of 1944 bits, this uses a memory buffer that is 5-10 bits wide and 1994 words long. With the hard decision method, the hard decision bits are output from the channel decoder only using a memory of 1944 bits resulting in an 80 to 90% reduction on the memory buffer.

This reduction in computational complexity vastly reduces the hardware and power consumption used to perform maximum likelihood MU-MIMO joint decoding. Table 4 shows a chip area and power consumption estimate for a 16 QAM MIMO system in 22 nm Complementary Metal Oxide Semiconductor (CMOS) technology at 0.8V at room temperature.

TABLE 4

| | | Normalized Power |
|---|---|---|
| Design Method | Area (um²) | (@ 500 MHz) |
| Exact & linear- | 17,559 | 1 |
| approximated soft- | | |
| symbol calculation | | |
| Proposed hard | 7,063 | 0.35 |
| symbol routing | | |

Table 5 shows a chip area and power consumption estimate for a 64-QAM MIMO system in 22 nm CMOS technology at 0.8V at room temperature.

TABLE 5

| | | Normalized Power |
|---|---|---|
| Design Method | Area (um²) | (@ 500 MHz) |
| Exact & linear- | 71,932 | 1 |
| approximated soft- | | |
| symbol calculation | | |
| Proposed hard | 28,001 | 0.33 |
| symbol routing | | |

In both cases, the hard decision method for symbol feedback from the decoder reduces the chip area and power consumption by 60% to 70%.

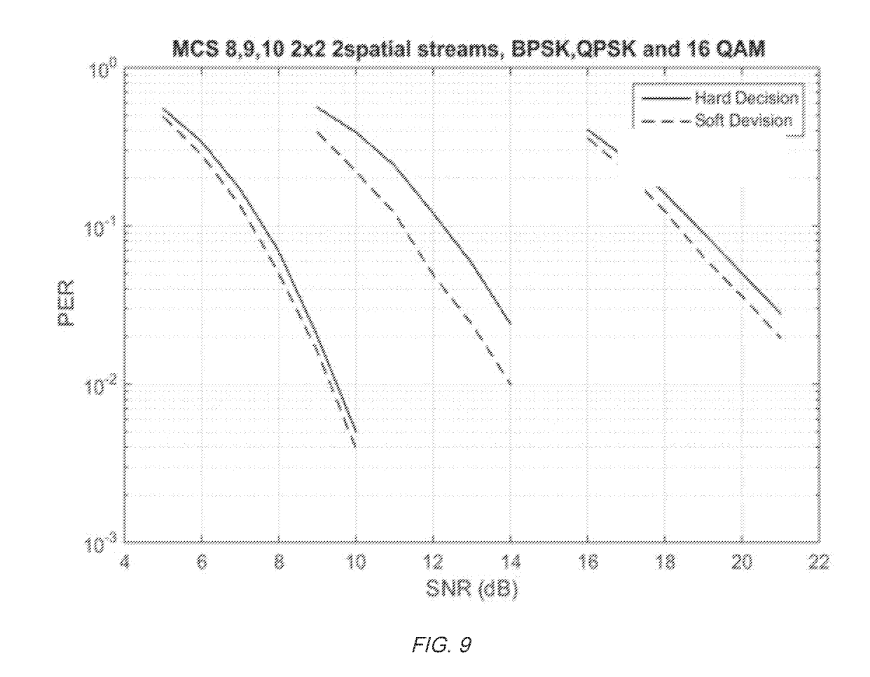

FIG. 9 shows the performance difference when implementing iterative decoding using soft decision feedback and when using hard decision feedback from the channel decoder for a 2×2 MIMO system in accordance with some embodiments described herein. Results are shown for BPSK, QPSK and 16-QAM. For 16-QAM, the hard decision feedback only shows about a 0.7 dB reduction in performance from the more complex soft decision feedback. Notably, the 64-QAM and 256-QAM modulation methods show no appreciable degradation when using hard decision feedback. This can be intuitively explained since increasing the order of the modulation format produces hard decisions with more granularity which more closely match the soft symbol estimates.

The above described embodiments may be implemented in a variety of different ways. The examples below illustrate various embodiments. It will be apparent that additional embodiments are possible which are not specifically listed below.

Example 1 is an apparatus of an access point (AP) configured to perform iterative decoding for multi-user multiple-input multiple-output (MU-MIMO) operation, the apparatus comprising: a channel decoder; and a Soft-Input Soft-Output Multiple-Input Multiple-Output detector (SISO MIMO detector) comprising: circuitry to generate soft symbol outputs for each of a plurality of received spatial streams, wherein the received spatial streams are received from a plurality of user stations (STAs); and circuitry to adjust a signal to noise plus interference ratio for the soft symbol outputs using channel statistics and using hard decisions from an output of the channel decoder; wherein the channel decoder is configured to receive soft binary information generated from the soft symbol outputs from the SISO MIMO detector.

In Example 2, the subject matter of Example 1 optionally includes wherein the channel decoder and the SISO MIMO detector are configured to iteratively calculate the soft symbol outputs from the SISO MIMO detector and the hard decisions provided to the SISO MIMO detector from the channel decoder prior to outputting detected data.

In Example 3, the subject matter of any one or more of Examples 1-2 optionally include further comprising a conversion module configured to generate the soft binary information in the form of binary Log-Likelihood Ratios from the soft symbol outputs.

In Example 4, the subject matter of any one or more of Examples 1-3 optionally include further comprising a symbol mapper configured to generate hard symbols from the hard decisions that are calculated by the channel decoder.

In Example 5, the subject matter of any one or more of Examples 1-4 optionally include wherein the channel decoder is configured to decode Low Density Parity Code (LDPC).

In Example 6, the subject matter of any one or more of Examples 1-5 optionally include wherein the channel decoder is configured to decode Binary Convolutional Code (BCC).

In Example 7, the subject matter of any one or more of Examples 1-6 optionally include where the apparatus is configured to receive one or more modulation formats: Binary Phase Shift Key (BPSK), Quadrature Phase Shift Key (QPSK), 16 Quadrature Amplitude Modulation (16-QAM), 64-QAM, 256-QAM or a modulation format with a defined In-Phase and Quadrature-Phase (IQ) constellation map.

In Example 8, the subject matter of any one or more of Examples 1-7 optionally include in which the SISO MIMO detector implements any one of: Minimum Mean Squared Error (MMSE), Zero Forcing (ZF), or Maximum Likelihood (ML).

In Example 9, the subject matter of any one or more of Examples 1-8 optionally include further comprising physical layer circuitry, wherein the physical layer circuitry comprises the SISO MIMO detector and the channel decoder.

In Example 10, the subject matter of Example 9 optionally includes further comprising: media access control (MAC) circuitry coupled to the physical layer circuitry, and processing circuitry coupled to the media access control circuitry, wherein the physical layer circuitry is coupled to a plurality of antenna elements; wherein the MAC circuitry controls network access via the physical layer circuitry for the processing circuitry.

In Example 11, the subject matter of Example 10 optionally includes further comprising the plurality of antenna elements coupled to the SISO MIMO detector.

Example 12 is a non-transitory computer readable medium comprising instructions that, when executed by one or more processors of a device comprising an Access Point (AP) wireless receiver, cause the device to: adapt a Soft-Input Soft-Output Multiple-Input Multiple-Output detector (SISO MIMO detector) and generate soft symbol outputs for each of a plurality of spatial streams received from a plurality of STAs; decode soft binary data using a channel decoder to provide hard decisions; adjust the SISO-MIMO Detector using channel statistics and using the hard decisions to alter a signal to noise plus interference ratio of the soft symbol outputs.

In Example 13, the subject matter of Example 12 optionally includes wherein the instructions further cause the wireless receiver to iterate between the soft symbol outputs and the hard decisions provided by the channel decoder one or more times.

In Example 14, the subject matter of any one or more of Examples 12-13 optionally include wherein the instructions further cause the wireless receiver to convert the soft symbol outputs to binary Log-Likelihood Ratios (LLRs) which are then decoded by the channel decoder.

In Example 15, the subject matter of any one or more of Examples 12-14 optionally include wherein the instructions further cause the wireless receiver to convert the hard decisions provided by the channel decoder into hard symbol constellation points which are then used by the SISO MIMO detector.

In Example 16, the subject matter of any one or more of Examples 12-15 optionally include wherein the instructions further cause the channel decoder to decode any one or more of: Low Density Parity Code (LDPC), Binary Convolutional Code (BCC), or Turbo Code.

In Example 17, the subject matter of any one or more of Examples 12-16 optionally include wherein the instructions further cause the wireless receiver to us a plurality of antennas to receive the spatial streams.

Example 18 is a method performed by an access point (AP) for iterative decoding of multiple-user multiple-input multiple-output (MU-MIMO) data, the method comprising: generating soft symbol outputs for each of a plurality of spatial streams received from a plurality of high-efficiency user stations (HE-STAs) using a Soft-Input Soft-Output Multiple-Input Multiple-Output detector (SISO MIMO detector) of the AP; decoding soft binary data using a channel decoder to provide hard decisions; and adjusting the SISO-MIMO Detector using channel statistics and using the hard decisions to alter a signal to noise plus interference ratio of the soft symbol outputs.

In Example 19, the subject matter of Example 18 optionally includes further comprising: iteratively calculating the soft symbol outputs from the SISO MIMO detector and the hard decisions provided to the SISO MIMO detector from the channel decoder prior to outputting detected data.

In Example 20, the subject matter of Example 19 optionally includes further comprising: converting, by a soft symbol to binary converter, the soft symbol outputs to binary Log-Likelihood Ratios (LLRs) which are then decoded by the channel decoder; and converting the hard decisions provided by the channel decoder into hard symbol constellation points which are then used by the SISO MIMO detector.

Example 21 is an apparatus of a wireless device with iterative decoding for multiple-input multiple-output (MIMO), comprising: a Soft-Input Soft-Output Multiple-Input Multiple-Output detector (SISO MIMO detector) comprising: means for generating soft symbol outputs for each of a plurality of received spatial streams; and means for adjusting a signal to noise plus interference ratio for the soft symbol outputs using channel statistics and using hard decisions from an output of a channel decoder; means for receiving soft binary information generated from the soft symbol outputs from the SISO MIMO detector.

In Example 22, the subject matter of Example 21 optionally includes further comprising means for iteratively calculating between the soft symbol outputs from the SISO MIMO detector and the hard decisions provided to the SISO MIMO detector from the channel decoder.

In Example 23, the subject matter of any one or more of Examples 21-22 optionally include further comprising means for generating the soft binary information in the form of binary Log-Likelihood Ratios from the soft symbol outputs.

In Example 24, the subject matter of any one or more of Examples 21-23 optionally include further comprising means for generating hard symbols from the hard decisions that are calculated by the channel decoder.

Example 25 is an apparatus of a user station (STA) to perform iterative decoding for multiple-input multiple-output (MIMO) operation, the apparatus comprising: a channel decoder; and a Soft-Input Soft-Output Multiple-Input Multiple-Output detector (SISO MIMO detector) comprising: circuitry to generate soft symbol outputs for each of a plurality of received spatial streams wherein the received spatial streams are received from a plurality of access points (APs); and circuitry to adjust a signal to noise plus interference ratio for the soft symbol outputs using channel statistics and using hard decisions from an output of the channel decoder, wherein the channel decoder is configured to receive soft binary information generated from the soft symbol outputs from the SISO MIMO detector.

In Example 26, the subject matter of Example 25 optionally includes wherein the channel decoder and the SISO MIMO detector are configured to iteratively calculate the soft symbol outputs from the SISO MIMO detector and the hard decisions provided to the SISO MIMO detector from the channel decoder prior to outputting detected data.

In Example 27, the subject matter of any one or more of Examples 25-26 optionally include further comprising a conversion module configured to generate the soft binary information in the form of binary Log-Likelihood Ratios from the soft symbol outputs; and a symbol mapper configured to generate hard symbols from the hard decisions that are calculated by the channel decoder.

In Example 28, the subject matter of any one or more of Examples 25-27 optionally include further comprising: a plurality of antennas coupled to the SISO MIMO detector that receive the plurality of received spatial streams from the plurality of APs.

Example 29 is a non-transitory computer readable medium comprising instructions that, when executed by one or more processors of a device comprising a user station (STA), cause the device to: adapt a Soft-Input Soft-Output Multiple-Input Multiple-Output detector (SISO MIMO detector) and generate soft symbol outputs for each of a plurality of spatial streams received from a plurality of access points (APs) decode soft binary data using a channel decoder to provide hard decisions; and adjust the SISO-MIMO Detector using channel statistics and using the hard decisions to alter a signal to noise plus interference ratio of the soft symbol outputs.

In Example 30, the subject matter of Example 29 optionally includes wherein the instructions further cause the wireless receiver to iterate between the soft symbol outputs and the hard decisions provided by the channel decoder one or more times.

In Example 31, the subject matter of any one or more of Examples 29-30 optionally include wherein the instructions further cause the wireless receiver to convert the soft symbol outputs to binary Log-Likelihood Ratios (LLRs) which are then decoded by the channel decoder.

In Example 32, the subject matter of any one or more of Examples 29-31 optionally include wherein the instructions further cause the wireless receiver to convert the hard decisions provided by the channel decoder into hard symbol constellation points which are then used by the SISO MIMO detector.

Example 33 is a method performed by a station (STA) for iterative decoding of multiple-user multiple-input multiple-output (MU-MIMO) data, the method comprising: generating soft symbol outputs for each of a plurality of spatial streams received from a plurality of access points (APs) using a Soft-Input Soft-Output Multiple-Input Multiple-Output detector (SISO MIMO detector) of the STA; decoding soft binary data using a channel decoder to provide hard decisions; and adjusting the SISO-MIMO Detector using channel statistics and using the hard decisions to alter a signal to noise plus interference ratio of the soft symbol outputs.

In Example 34, the subject matter of Example 33 optionally includes further comprising: iteratively calculating the soft symbol outputs from the SISO MIMO detector and the hard decisions provided to the SISO MIMO detector from the channel decoder prior to outputting detected data.

In Example 35, the subject matter of any one or more of Examples 33-34 optionally include further comprising: converting, by a soft symbol to binary converter, the soft symbol outputs to binary Log-Likelihood Ratios (LLRs) which are then decoded by the channel decoder; and converting the hard decisions provided by the channel decoder into hard symbol constellation points which are then used by the SISO MIMO detector.

Example 36 is an apparatus of a user station (STA) with iterative decoding for multiple-input multiple-output (MIMO), comprising: a Soft-input Soft-Output Multiple-Input Multiple-Output detector (SISO MIMO detector) comprising: means for generating soft symbol outputs for each of a plurality of spatial streams received from a plurality of access points (APs) using a Soft-Input Soft-Output Multiple-Input Multiple-Output detector (SISO MIMO detector) of the STA; and means for adjusting a signal to noise plus interference ratio for the soft symbol outputs using channel statistics and using hard decisions from an output of a channel decoder; means for receiving soft binary information generated from the soft symbol outputs from the SISO MIMO detector.

In Example 37, the subject matter of Example 36 optionally includes further comprising means for iteratively calculating between the soft symbol outputs from the SISO MIMO detector and the hard decisions provided to the SISO MIMO detector from the channel decoder.

In Example 38, the subject matter of any one or more of Examples 36-37 optionally include further comprising means for generating the soft binary information in the form of binary Log-Likelihood Ratios from the soft symbol outputs.

In Example 39, the subject matter of any one or more of Examples 36-38 optionally include further comprising means for generating hard symbols from the hard decisions that are calculated by the channel decoder.

Example 40 is a computer readable medium comprising instructions that, when executed by one or more processors, cause a device to perform any method of the claims above.

Additionally, any such examples or other embodiments described herein may be implemented using the described elements with other elements or in any other acceptable order that enables low complexity iterative decoding for MU-MIMO systems as described herein.

FIG. 10 illustrates a wireless LAN showing an Access Point, Station Devices and Hew Devices that may be used in accordance with some embodiments described herein. In some embodiments, the network 1000 may be a High Efficiency Wireless Local Area Network (HEW) network. In some embodiments, the network 1000 may be a Wireless Local Area Network (WLAN) or a Wi-Fi network. These embodiments are not limiting, however, as some embodiments of the network 1000 may include a combination of such networks.

That is, the network 1000 may support HEW devices in some cases, non HEW devices in some cases, and a combination of HEW devices and non HEW devices in some cases. Accordingly, it is understood that although techniques described herein may refer to either a non HEW device or to an HEW device, such techniques may be applicable to both non HEW devices and HEW devices in some cases.

The network 1000 may include a master station or Access Point (AP) 1002, a plurality of user stations or station devices (STAs) 1003 and a plurality of HEW stations 1004 (HEW devices). In some embodiments, the STAs 1003 may be legacy stations. These embodiments are not limiting, however, as the STAs 1003 may be HEW devices or may support HEW operation in some embodiments. The master station 1002 may be arranged to communicate with the STAs 1003 and/or the HEW stations 1004 in accordance with one or more of the IEEE 802.11 standards. In accordance with some HEW embodiments, an access point may operate as the master station 1002 and may be arranged to contend for a wireless medium (e.g., during a contention period) to receive exclusive control of the medium for an HEW control period (i.e., a transmission opportunity (TXOP)). The master station 1002 may, for example, transmit a master-sync or control transmission at the beginning of the HEW control period to indicate, among other things, which HEW stations 104 are scheduled for communication during the HEW control period. During the HEW control period, the scheduled HEW stations 1004 may communicate with the master station 1002 in accordance with a non-contention based multiple access technique. This is unlike conventional Wi-Fi communications in which devices communicate in accordance with a contention-based communication technique, rather than a non-contention based multiple access technique. During the HEW control period, the master station 1002 may communicate with HEW stations 1004 using one or more HEW frames. During the HEW control period, STAs 1003 not operating as HEW devices may refrain from communicating in some cases. In some embodiments, the master-sync transmission may be referred to as a control and schedule transmission.

In some embodiments, the AP 1002 may transmit a low density parity check (LDPC) codeword for reception at the STA 1003. In some embodiments, the LDPC codeword may be transmitted as part of an orthogonal frequency division multiplexing (OFDM) signal. These embodiments will be described in more detail below.

In some embodiments, the multiple-access technique used during the HEW control period may be a scheduled orthogonal frequency division multiple access (OFDMA) technique, although this is not a requirement. In some embodiments, the multiple access technique may be a time-division multiple access (TDMA) technique or a frequency division multiple access (FDMA) technique. In some embodiments, the multiple access technique may be a space-division multiple access (SDMA) technique including a multi-user (MU) multiple-input multiple-output (MIMO) (MU-MIMO) technique. These multiple-access techniques used during the HEW control period may be configured for uplink or downlink data communications.

The master station 1002 may also communicate with STAs 1003 and/or other legacy stations in accordance with legacy IEEE 802.11 communication techniques. In some embodiments, the master station 102 may also be configurable to communicate with the HEW stations 1004 outside the HEW control period in accordance with legacy IEEE 802.11 communication techniques, although this is not a requirement.

In some embodiments, the HEW communications during the control period may be configurable to use one of 20 MHz, 40 MHz, or 80 MHz contiguous bandwidths or an 80+80 MHz (160 MHz) non-contiguous bandwidth. In some embodiments, a 320 MHz channel width may be used. In some embodiments, subchannel bandwidths less than 20 MHz may also be used. In these embodiments, each channel or subchannel of an HEW communication may be configured for transmitting a number of spatial streams.

In accordance with embodiments, a master station 1002 and/or HEW stations 1004 may generate an HEW packet in accordance with a short preamble format or a long preamble format. The HEW packet may comprise a legacy signal field (L-SIG) followed by one or more high-efficiency (HE) signal fields (HE-SIG) and an HE long-training field (HE-LTF). For the short preamble format, the fields may be configured for shorter-delay spread channels. For the long preamble format, the fields may be configured for longer-delay spread channels. These embodiments are described in more detail below. It should be noted that the terms “HEW” and “HE” may be used interchangeably and both terms may refer to high-efficiency Wireless Local Area Network operation and/or high-efficiency Wi-Fi operation.

FIG. 11 illustrates a user station (STA) and an access point (AP) in accordance with some embodiments described herein. It should be noted that in some embodiments, the AP 1002 may be a stationary non-mobile device. The STA 1100 may be suitable for use as an STA 1003 as depicted in FIG. 10, while the AP 1150 may be suitable for use as an AP 1002 as depicted in FIG. 10. In addition, the STA 200 may also be suitable for use as an HEW device 1004 as shown in FIG. 10, such as an HEW station.

The STA 1100 may include physical layer circuitry 202 and a transceiver 1105, one or both of which may enable transmission and reception of signals to and from the AP 1150, other APs, other STAs or other devices using one or more antennas 1101. As an example, the physical layer circuitry 1102 may perform various encoding and decoding functions that may include formation of baseband signals for transmission and decoding of received signals. As another example, the transceiver 1105 may perform various transmission and reception functions such as conversion of signals between a baseband range and a Radio Frequency (RF) range. Accordingly, the physical layer circuitry 1102 and the transceiver 205 may be separate components or may be part of a combined component. In addition, some of the described functionality related to transmission and reception of signals may be performed by a combination that may include one, any or all of the physical layer circuitry 1102, the transceiver 1105, and other components or layers.

The AP 1150 may include physical layer circuitry 1152 and a transceiver 1155, one or both of which may enable transmission and reception for transmission and reception of signals to and from the STA 1100, other APs, other STAs or other devices using one or more antennas 1151. The physical layer circuitry 1152 and the transceiver 1155 may perform various functions similar to those described regarding the STA 1100 previously. Accordingly, the physical layer circuitry 1152 and the transceiver 1155 may be separate components or may be part of a combined component. In addition, some of the described functionality related to transmission and reception of signals may be performed by a combination that may include one, any or all of the physical layer circuitry 1152, the transceiver 255, and other components or layers.

The STA 1100 may also include medium access control layer (MAC) circuitry 1104 for controlling access to the wireless medium, while the AP 1150 may also include medium access control layer (MAC) circuitry 1154 for controlling access to the wireless medium. The STA 1100 may also include processing circuitry 1106 and memory 1108 arranged to perform the operations described herein. The AP 1150 may also include processing circuitry 1156 and memory 1158 arranged to perform the operations described herein. The AP 1150 may also include one or more interfaces 1160, which may enable communication with other components, including other APs 1002 (FIG. 10). In addition, the interfaces 1160 may enable communication with other components that may not be shown in FIG. 10, including components external to the network 1000. The interfaces 1160 may be wired or wireless or a combination thereof.

The antennas 1101, 1151 may comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas 1101, 1151 may be effectively separated to take advantage of spatial diversity and the different channel characteristics that may result.

In some embodiments, the STA 1100 or the AP 1150 may be a mobile device and may be a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a wearable device such as a medical device (e.g., a heart rate monitor, a blood pressure monitor, etc.), or other device that may receive and/or transmit information wirelessly. In some embodiments, the STA 1100 or AP 1150 may be configured to operate in accordance with 802.11 standards, although the scope of the embodiments is not limited in this respect. Mobile devices or other devices in some embodiments may be configured to operate according to other protocols or standards, including other IEEE standards, Third Generation Partnership Project (3GPP) standards or other standards. In some embodiments, the STA 200, AP 250 or other device may include one or more of a keyboard, a display, a non-volatile memory port, multiple antennas, a graphics processor, an application processor, speakers, and other mobile device elements. The display may be an LCD screen including a touch screen.

Although the STA 1100 and the AP 1150 are each illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

Embodiments may be implemented in one or a combination of hardware, firmware and software. Embodiments may also be implemented as instructions stored on a computer-readable storage device, which may be read and executed by at least one processor to perform the operations described herein. A computer-readable storage device may include any non-transitory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. Some embodiments may include one or more processors and may be configured with instructions stored on a computer-readable storage device.

It should be noted that in some embodiments, an apparatus used by the STA 1100 and/or AP 1150 may include various components of the STA 1100 and/or AP 1150 as shown in FIG. 11. Accordingly, techniques and operations described herein that refer to the STA 1100 (or 1003 or 1004) may be applicable to an apparatus for an STA. In addition, techniques and operations described herein that refer to the AP 1150 (or 1002) may be applicable to an apparatus for an AP.

In some embodiments, the STA 1100 may be configured as an HEW device 1004 (FIG. 10), and may communicate using OFDM communication signals over a multicarrier communication channel. Accordingly, in some cases the STA 1100 may be configured to receive signals in accordance with specific communication standards, such as the Institute of Electrical and Electronics Engineers (IEEE) standards including IEEE 802.11-2012, 802.11n-2009 and/or 802.11 ac-2013 standards and/or proposed specifications for WLANs including proposed HEW standards, although the scope of the embodiments is not limited in this respect as they may also be suitable to transmit and/or receive communications in accordance with other techniques and standards. In some other embodiments, the STA 1000 configured as an HEW device 1004 may be configured to receive signals that were transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

Embodiments disclosed herein provide two preamble formats for High Efficiency (HE) Wireless LAN standards specification that is under development in the IEEE Task Group I lax (TGax).

In accordance with embodiments, the AP 1002 may encode a block of input bits according to a parity check matrix to produce a low density parity check (LDPC) codeword. The parity check matrix may be included in a group of candidate parity check matrixes that includes a base parity check matrix and an expanded parity check matrix. An LDPC codeword length may be smaller for the base parity check matrix than for the expanded parity check matrix. In some embodiments, the base parity check matrix may be used for the encoding when the LDPC codeword is transmitted for a legacy user station STA 1003. The expanded parity check matrix may be used when the LDPC codeword is transmitted for a non-legacy STA 1003. These embodiments will be described in more detail below.

In some embodiments, the channel resources may be used for downlink transmission by the AP 1002 and for uplink transmissions by the STAs 103. That is, a time-division duplex (TDD) format may be used. In some cases, the channel resources may include multiple channels, such as the 20 MHz channels previously described. The channels may include multiple sub-channels or may be divided into multiple sub-channels for the uplink transmissions to accommodate multiple access for multiple STAs 1003. The downlink transmissions may or may not utilize the same format.

In some embodiments, the downlink sub-channels may comprise a predetermined bandwidth. As a non-limiting example, the sub-channels may each span 2.03125 MHz, the channel may span 20 MHz, and the channel may include eight or nine sub-channels. Although reference may be made to a sub-channel of 2.03125 MHz for illustrative purposes, embodiments are not limited to this example value, and any suitable frequency span for the sub-channels may be used. In some embodiments, the frequency span for the sub-channel may be based on a value included in an 802.11 standard (such as 802.11ax), a 3GPP standard or other standard.

In some embodiments, the sub-channels may comprise multiple sub-carriers. Although not limited as such, the sub-carriers may be used for transmission and/or reception of OFDM or OFDMA signals. As an example, each sub-channel may include a group of contiguous sub-carriers spaced apart by a predetermined sub-carrier spacing. As another example, each sub-channel may include a group of non-contiguous sub-carriers. That is, the channel may be divided into a set of contiguous sub-carriers spaced apart by the predetermined sub-carrier spacing, and each sub-channel may include a distributed or interleaved subset of those sub-carriers. The sub-carrier spacing may take a value such as 78.125 kHz, 312.5 kHz or 15 kHz, although these example values are not limiting. Other suitable values that may or may not be part of an 802.11 or 3GPP standard or other standard may also be used in some cases. As an example, for a 78.125 kHz sub-carrier spacing, a sub-channel may comprise 26 contiguous sub-carriers or a bandwidth of 2.03125 MHz.

In some embodiments, an OFDM signal may be based on different arrangements of sub-carriers during some OFDM symbol periods. As an example, a first and a second OFDM symbol period may be based on a first and second sub-carrier spacing, respectively. It should be noted that the sub-carrier spacing and the OFDM symbol period are inversely related for OFDM. Accordingly, when the second sub-carrier spacing is reduced in comparison to the first sub-carrier spacing, the second OFDM symbol period may be increased accordingly to maintain that inverse relationship. For instance, a first sub-carrier spacing of 312.5 kHz may be used along with a first OFDM symbol period of 3.2 microseconds (usec) (without guard intervals). A scaling of four may be applied to those numbers to produce a second sub-carrier spacing of 78.125 kHz and a second OFDM symbol period of 12.8 microseconds (usec). Embodiments are not limited to integer scaling, however, as any suitable scaling factor may be used in conjunction with the inverse relationship described above. Embodiments are also not limited to the usage of two different sub-carrier spacings, as one spacing or more than two spacings may be used in some cases.

In some embodiments, a first sub-carrier spacing (and corresponding first OFDM symbol period) may be used for a system or may be included in a standard. A second sub-carrier spacing and OFDM symbol period may also be used for the system or may also be included in the standard for any suitable reason. As an example, different sub-carrier spacings and OFDM symbol periods may be desired for performance reasons. As another example, the second sub-carrier spacing and second OFDM symbol period may be related to legacy operation of the system or standard.

1. An apparatus of an access point (AP) configured to perform iterative decoding for multi-user multiple-input multiple-output (MU-MIMO) operation, the apparatus comprising:
a channel decoder; and
a Soft-Input Soft-Output Multiple-Input Multiple-Output detector (SISO MIMO detector) comprising:
circuitry to generate soft symbol outputs for each of a plurality of received spatial streams, wherein the spatial streams are received from a plurality of user stations (STAs); and
circuitry to adjust a signal to noise plus interference ratio for the soft symbol outputs using channel statistics and using hard decisions from an output of the channel decoder;
wherein the channel decoder is configured to receive soft binary information generated from the soft symbol outputs from the SISO MIMO detector.

2. The apparatus of claim 1 wherein the channel decoder and the SISO MIMO detector are configured to iteratively calculate the soft symbol outputs from the SISO MIMO detector and the hard decisions provided to the SISO MIMO detector from the channel decoder prior to outputting detected data.

3. The apparatus of claim 1 further comprising circuitry to generate the soft binary information in the form of binary Log-Likelihood Ratios from the soft symbol outputs.

4. The apparatus of claim 1 further comprising a symbol mapper configured to generate hard symbols from the hard decisions that are calculated by the channel decoder.

5. The apparatus of claim 1 wherein the channel decoder is configured to decode Low Density Parity Code (LDPC).

6. The apparatus of claim 1 wherein the channel decoder is configured to decode Binary Convolutional Code (BCC).

7. The apparatus of claim 1 where the apparatus is configured to receive one or more modulation formats:
Binary Phase Shift Key (BPSK), Quadrature Phase Shift Key (QPSK), 16 Quadrature Amplitude Modulation (16-QAM), 64-QAM, 256-QAM or a modulation format with a defined In-Phase and Quadrature-Phase (IQ) constellation map.

8. The apparatus of claim 1 in which the SISO MIMO detector implements any one of: Minimum Mean Squared Error (MMSE), Zero Forcing (ZF), or Maximum Likelihood (ML).

9. The apparatus of claim 1 further comprising physical layer circuitry, wherein the physical layer circuitry comprises the SISO MIMO detector and the channel decoder.

10. The apparatus of claim 9 further comprising:
media access control (MAC) circuitry coupled to the physical layer circuitry; and
processing circuitry coupled to the media access control circuitry, wherein the physical layer circuitry is coupled to a plurality of antenna elements;
wherein the MAC circuitry controls network access via the physical layer circuitry for the processing circuitry.

11. The apparatus of claim 10 further comprising the plurality of antenna elements coupled to the SISO MIMO detector.

12. A non-transitory computer readable medium comprising instructions that, when executed by one or more processors of a device comprising a wireless receiver, cause the device to:
adapt a Soft-Input Soft-Output Multiple-Input Multiple-Output detector (SISO MIMO detector) and generate soft symbol outputs for each of a plurality of spatial streams;
decode soft binary data using a channel decoder to provide hard decisions;
adjust the SISO-MIMO Detector using channel statistics and using the hard decisions to alter a signal to noise plus interference ratio of the soft symbol outputs.

13. The non-transitory computer readable medium of claim 12 wherein the instructions further cause the wireless receiver to iterate between the soft symbol outputs and the hard decisions provided by the channel decoder one or more times.

14. The non-transitory computer readable medium of claim 12 wherein the instructions further cause the wireless receiver to convert the soft symbol outputs to binary Log-Likelihood Ratios (LLRs) which are then decoded by the channel decoder.

15. The non-transitory computer readable medium of claim 12 wherein the instructions further cause the wireless receiver to convert the hard decisions provided by the channel decoder into hard symbol constellation points which are then used by the SISO MIMO detector.

16. The non-transitory computer readable medium of claim 12 wherein the instructions further cause the channel decoder to decode any one or more of:
Low Density Parity Code (LDPC), Binary Convolutional Code (BCC), or Turbo Code.

17. The non-transitory computer readable medium of claim 12 wherein the instructions further cause the wireless receiver to us a plurality of antennas to receive the spatial streams.

18. A method performed by an access point (AP) for iterative decoding of multiple-user multiple-input multiple-output (MU-MIMO) data, the method comprising:
generating soft symbol outputs for each of a plurality of spatial streams received from a plurality of high-efficiency user stations (HE-STAs) using a Soft-Input Soft-Output Multiple-Input Multiple-Output detector (SISO MIMO detector) of the AP;
decoding soft binary data using a channel decoder to provide hard decisions, and
adjusting the SISO-MIMO Detector using channel statistics and using the hard decisions to alter a signal to noise plus interference ratio of the soft symbol outputs.

19. The method of claim 18 further comprising:
iteratively calculating the soft symbol outputs from the SISO MIMO detector and the hard decisions provided to the SISO MIMO detector from the channel decoder prior to outputting detected data.

20. The method of claim 18 further comprising:
converting, by a soft symbol to binary converter, the soft symbol outputs to binary Log-Likelihood Ratios (LLRs) which are then decoded by the channel decoder; and
converting the hard decisions provided by the channel decoder into hard symbol constellation points which are then used by the SISO MIMO detector.

21. An apparatus of a user station (STA) to perform iterative decoding for multiple-input multiple-output (MIMO) operation, the apparatus comprising:
a channel decoder; and
a Soft-input Soft-Output Multiple-Input Multiple-Output detector (SISO MIMO detector) comprising:
circuitry to generate soft symbol outputs for each of a plurality of received spatial streams wherein the received spatial streams are received from a plurality of access points (APs); and
circuitry to adjust a signal to noise plus interference ratio for the soft symbol outputs using channel statistics and using hard decisions from an output of the channel decoder;
wherein the channel decoder is configured to receive soft binary information generated from the soft symbol outputs from the SISO MIMO detector.

22. The apparatus of claim 21 wherein the channel decoder and the SISO MIMO detector are configured to iteratively calculate the soft symbol outputs from the SISO MIMO detector and the hard decisions provided to the SISO MIMO detector from the channel decoder prior to outputting detected data.

23. The apparatus of claim 21 further comprising circuitry to generate the soft binary information in the form of binary Log-Likelihood Ratios from the soft symbol outputs; and
a symbol mapper configured to generate hard symbols from the hard decisions that are calculated by the channel decoder.

24. The apparatus of claim 21 further comprising:
a plurality of antennas coupled to the SISO MIMO detector that receive the plurality of received spatial streams from the plurality of APs.
